(19) United States
(12) Patent Application Publication
(10) Pub. No.: US 2015/0327061 A1
(43) Pub. Date: Nov. 12, 2015

(54) SYSTEM AND METHOD FOR GEOLOCALIZED SOCIAL NETWORKING

(71) Applicant: Annecto Inc., Ottawa (CA)

(72) Inventors: Mathieu Haddad, Ottawa (CA); Prabhdeep Singh, Ottawa (CA); May Shawi, Ottawa (CA)

(21) Appl. No.: 14/273,685

(22) Filed: May 9, 2014

(51) Int. Cl. H04W 12/06; H04W 76/02; H04W 4/02; H04L 29/06; H04L 29/08

(52) U.S. Cl. CPC H04W 12/06; H04L 65/403; H04L 67/306; H04W 4/02; H04W 76/02; H04L 67/12

(57) ABSTRACT

A system and method which allow for connecting users with people of interest based on preferences and current location. The system allows users to connect when on board of the same transportation means such as an airplane. A wireless network is provided which is connected to a server including profile information of different users. The server makes the profile of a given user available for viewing by others depending on a number of factors including the current preferences of the given user (whether they allow other users to contact them or not at the given moment) and/or depending on the presence of a match between the profiles and preferences of the users. Using the current system, users may chat in real time using mobile phones over the wireless network. A method is also described which allow for managing and securing the access of one user to another based on each user's current location.

### BACKGROUND

(a) Field

The subject matter disclosed generally relates to the field of networking. More particularly, the subject matter relates to geolocalized social networking.

(b) Related Prior Art

With the proliferation of portable computing devices users are becoming more reliant on information that is accessible via the Internet. Accordingly, the Internet connectivity available at these portable devices is frequently used to chat, socialize and communicate with friends and family.

One particular area in which the Internet use is expanding is in the field of social networking whether for dating or for professional means.

While the internet has succeeded in breaking down geographic distance between users, in person meeting remains the most important part of the social connectivity over the internet. The existing methods for connecting mobile users in-person is merely a mobile version of the traditional techniques whereby two users agree ahead of time to meet at a certain place at a given time.

There is therefore a need for a system and method which allow mobile users to connect based on preferences and geo-locations.

### SUMMARY

The present embodiments describe such system and method.

In one aspect, there is provided a computer implemented method for connecting users on board of a transportation vehicle, the method comprising: using an on-board transceiver, providing a wireless network capable of transmitting and receiving signals to and from portable devices on board of the transportation vehicle; receiving a first authentication request from a first mobile device associated with a first user having a first user profile and a first set of preferences; receiving a second authentication request from a second mobile device associated with a second user having a second user profile; and if a match exists between the first set of preferences and the second user profile making the first profile available for viewing on the first portable device.

According to an embodiment, the method further comprises:
detecting a user-request from the first user initiating a chatting session with the second user;
receiving messages from the first user and sending the received messages to the second user over the wireless network and vice versa.

According to an embodiment, the method further comprises storing user profiles and sets of preferences associated with subscribed users on an accessible memory device.

According to an embodiment, the method further comprises storing messages exchanged in a given chatting session on an accessible memory device.

According to an embodiment, users authenticated using social network login information associated with social networks with which the users have open accounts.

According to an embodiment, the method further comprises

According to an embodiment, the method further comprises

According to an embodiment, the security code is one of: flyer number, hashtag, and PIN.

In another aspect there is provided a system for connecting users on board of a transportation vehicle, the system comprising: a server having access to a memory device having stored thereon profile information for a plurality of users; a transceiver operably connected to the server, the transceiver being adapted to provide a wireless network capable of transmitting and receiving signals to and from portable devices on board of the transportation vehicle; and wherein the server is adapted to manage authentication requests between users including making available the profile information of a first user to a second user based on preferences and stored profile information associated with the first user and the second user.

According to an embodiment, the system is adapted to allow on board chatting between users over the wireless network.

According to an embodiment, the system detects a user-request from the first user initiating a chatting session with the second user; and receives messages from the first user and sends the received messages to the second user over the wireless network and vice versa.

According to an embodiment, the system is adapted to store the messages exchanged in a given chatting session on the memory device.

According to an embodiment, users are authenticated using social network login information associated with social networks with which the users have opened accounts.

According to an embodiment, the system is adapted to receive profile information for the users from the social networks and store said profile information on the memory device.

According to an embodiment, the system requests a security code for authenticating users.

According to an embodiment, the security code is one of: flyer number, hashtag, and PIN.

In a further aspect, there is provided a computer implemented method for managing a location-based networking system, the method comprising: detecting an event; detecting a time period and a first location for the event; providing a hashtag for the event and making the hashtag available to event participants via a communications network; providing a connection platform and a wireless network allowing event participants to connect using portable computing devices, the hashtag being used for authenticating into the location-based networking system; and geofencing the hashtag comprising establishing a virtual fence defining a second location within or around the first location, wherein in response to receiving an authentication request from a portable device associated with a given user, an authentication decision is made based on a timestamp of the authentication request and a current location of the portable device.

According to an embodiment, the method further comprises receiving location coordinates of the portable device and comparing whether or not the portable device exists within the second location defined by the virtual fence.

According to an embodiment, the method further comprises storing messages exchanged between users on an accessible memory device.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a non-limiting example of a transportation vehicle for implementing the embodiments;

FIGS. 2a to 2f are screen shots illustrating an exemplary operation of the embodiments from the users' portable devices;

FIG. 3 illustrates different location options for connecting with users using the present embodiments.

FIG. 4 illustrates an example of an area that represents a geofence for a given hashtag associated with an event;

FIG. 5 is flowchart of a method for connecting users on board of a transportation vehicle, in accordance with an embodiment;

FIG. 6 is flowchart of a method for managing a location-based networking system, in accordance with an embodiment; and

FIG. 7 illustrates an embodiment of a computing environment which is suitable for practicing the embodiments.

It will be noted that throughout the appended drawings, like features are identified by like reference numerals.

### DETAILED DESCRIPTION

A system and method which allow for connecting users with people of interest based on preferences and current location. The system allows users to connect when on board of the same transportation means such as an airplane. A wireless network is provided which is connected to a server including profile information of different users. The server makes the profile of a given user available for viewing by others depending on a number of factors including the current preferences of the given user (whether they allow other users to contact them or not at the given moment) and/or depending on the presence of a match between the profiles and preferences of the users. Using the current system, users may chat in real time using mobile phones over the wireless network. A method is also described which allow for managing and securing the access of one user to another based on each user's current location.

In one aspect, users may connect when on board of the same transportation means be it a plane, train, boat, bus, subway, metro, etc. In another aspect, users may connect when attending same events.

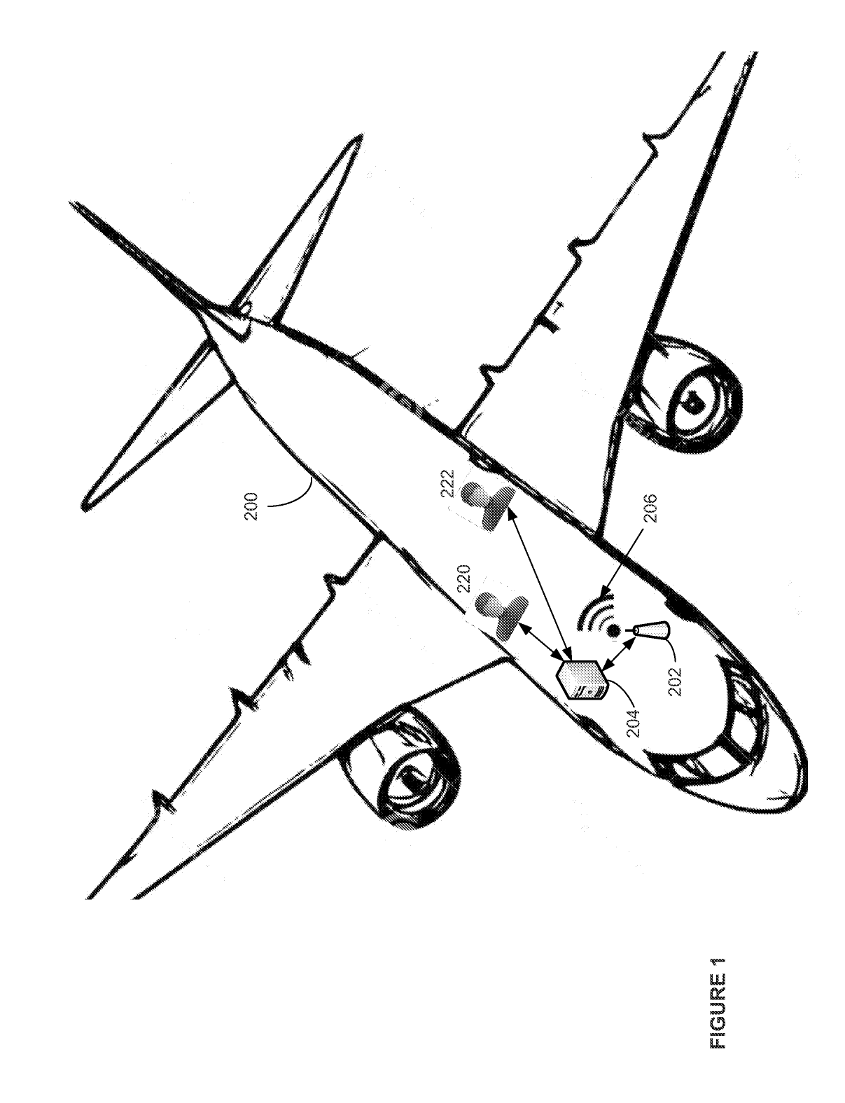

FIG. 1 illustrates a non-limiting example of a transportation vehicle for implementing the embodiments. As shown in FIG. 1, the transportation vehicle may be an airplane 200. However, the embodiments are not limited to airplanes and may very well be implemented in a variety of other transpiration vehicles. In one embodiment, the airplane 200 may be equipped with a transceiver 202 which is operably connected to a server 204 (which is provided on-board or remote or both) for providing an on-board wireless network 206 that may transmit and receive data over a range of frequencies that are compatible with portable devices such as smartphones, tablets, portable computers etc. and which are also compatible with the safety requirements associated with the transportation vehicle. An example of such wireless networks includes those which may be activated on-board of the plane while the cellular data transmission is turned off e.g. airplane mode etc. such as Wi-Fi or the like.

It should be noted that the wireless network 206 provided on the transportation vehicle 200 may and may not be connected to the internet. For example, the wireless network may be a local network that only provides users with the ability to connect with each other, without connecting them to external networks such as the internet. In other methods the wireless network may be connected to the internet and allows users to access external internet sites and web services.

In one aspect, the system may allow on-board users to explore one another using the on-board network 206 in accordance with profile and preferences and engage in chatting sessions over the on-board network 206.

In order to be able to use the system, users may have to download and install an application on their mobile device. The application may be implemented as a standalone application for connecting with on board users or users attending the same event, and may also be implemented with the application of the transporter such as the airline operating the transportation vehicle such as Air Canada or the like.

In an embodiment, the application may allow users to check on-board passengers even before boarding. For example, after the tickets are bought or 24 hours before boarding the system may make available to a given user, the profiles of other users who have signed in and have bought a ticket on the same flight and/or a return flight, and/or other flights at the same time etc. It should be noted that the system may only make available the profile of other users who have chosen to make their profile available for viewing or those whose profile match the preferences of the given user and/or vice versa.

In an embodiment, user may open an account by choosing a user name and password and filling their profile and preferences. Alternatively, users may authenticate using an existing social network account such as Facebook, twitter, and the like. The user may still need to provide their preferences. From a security point of view, the frequent flyer number and Personal Identification Number (PIN) will allow to have the real user identity available for the back-end process (data gathering/mining) and for the users of the app.

Using this info, the server 204 may perform data gathering and storage (on an accessible memory device) on users including as but not limited to:
User's Organization name
User's Position in the Organization
User's Industry
User's bio (main keywords)
User's location
User's main transportation modes and routes
User's email/accounts

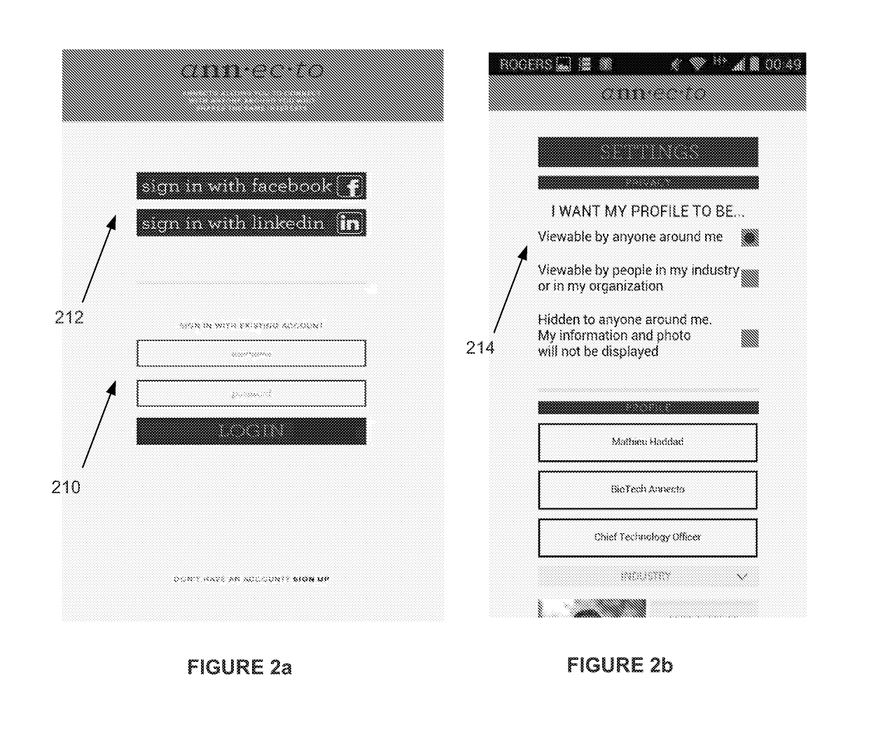

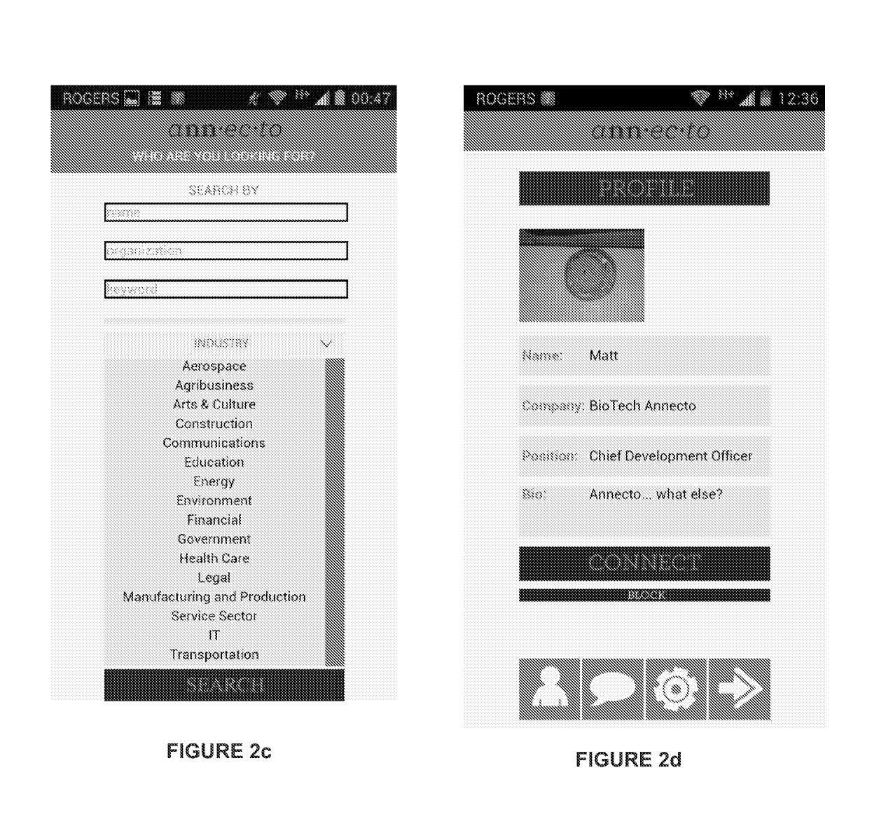

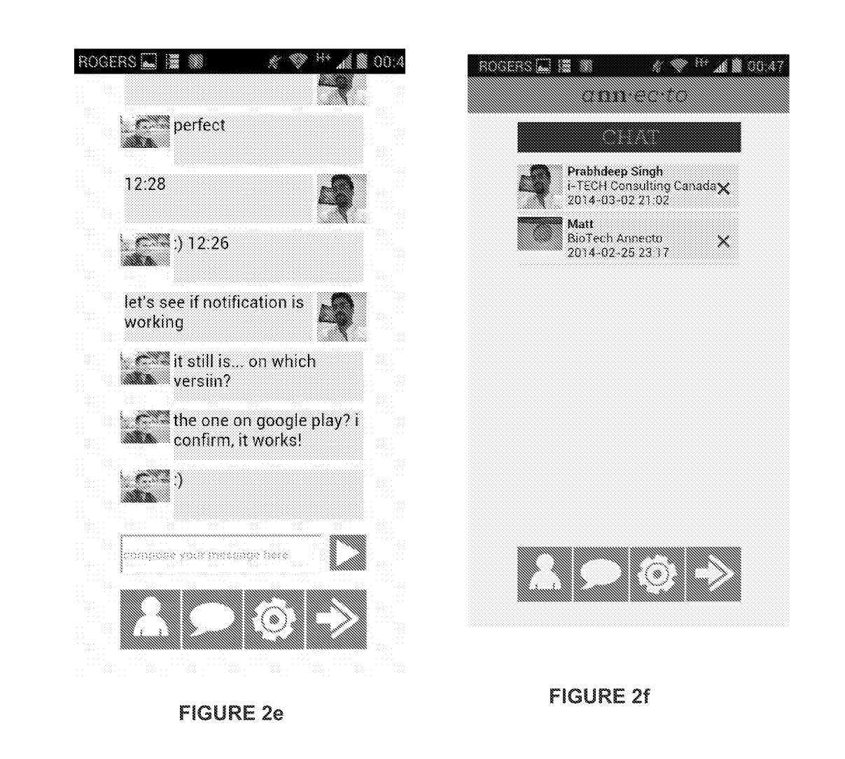

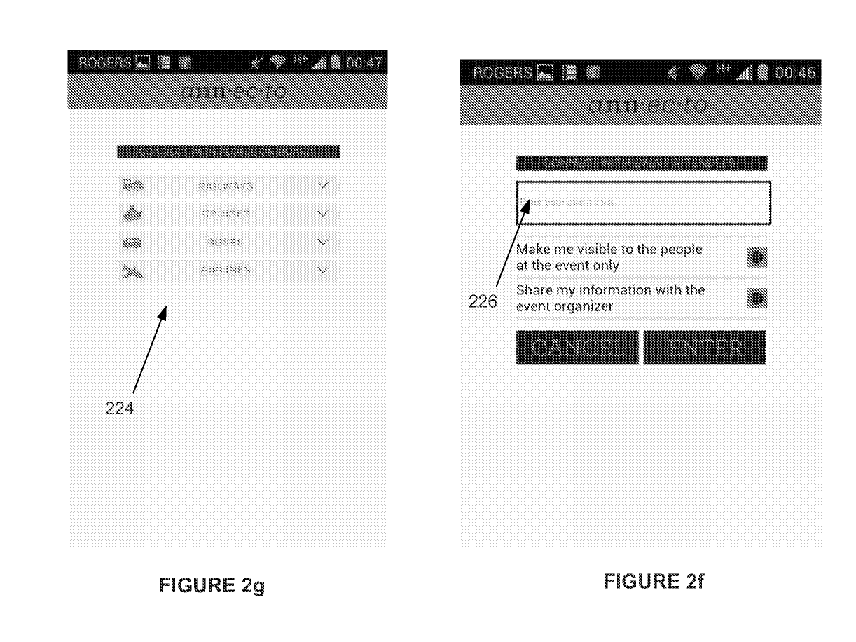

FIGS. 2a to 2f are screen shots illustrating an exemplary operation of the embodiments from the portable devices. The examples shown in FIGS. 2a to 2f show the embodiments implemented in an application knows as “Annecto”.

As shown in FIG. 2a, the user can authenticate at 210 using a user name and password for an account that is specific to the app or using social media logins (e.g., login information) as exemplified at 212. FIG. 2b illustrates the settings portion where the user can adjust their visibility as shown at 214 and modify their profile. Profile information may be stored on an accessible memory device of the server/database 204 to be accessible from different computing devices and for the server to decide on the visibility for other users. Messages and chatting sessions may also be stored on an accessible memory device of the server 204.

As discussed above, when the user checks in on a flight (or trip) or for example when the system identifies that a flight is scheduled within the next 24 hours (when online check-in is not available), the user can access the search page as shown in FIG. 2c to explore and filter other passengers' profiles who will be boarding the same flight. This could be done, in parallel with the check-in process (up to 24 hours prior to flight time). The server 204 may also decide whether or not the user can view and interact with passengers travelling on different routes at the same time.

The user may view the profile of another user as shown in FIG. 2d. If user decides to initiate contact with the other user they can hit connect and they may be directed to a conversation page as shown in FIG. 2e. The user may get a notification of new message if outside the conversation page. For example (number of messages may appear on the callout button in the bottom menu and as a push notification outside the app. By clicking on the push notification, the user may be directed in the chat page shown in FIG. 2f. If conversations contain unread messages, they may be highlighted as well as the number of unread messages. All messages may be kept on the server 204 which allows history to be accessible from any device.

Referring back to FIG. 1, if user 220 decided to engage in a conversation with user 222, a chatting session may be enabled over the on-board wireless network using the system described herein, whereby messages exchanged between the users 220 and 222 may pass through the server 204 and be recorded thereon for data mining and record keeping purposes.

As discussed above, the embodiments are not limited to airplanes and may very well be implemented with any other type of transportation. As shown in FIG. 2g, the user may choose the type of transportation they are traveling on from a menu 224 to then surf the list of available users to connect with.

In an embodiment, the system may require the user to enter a security code to identify the user. The security code may be a hashtag, a PIN, a reservation/confirmation number, a flyer number etc. The user may be prompted to enter such code upon authentication as exemplified at 226 in FIG. 2f before being granted access.

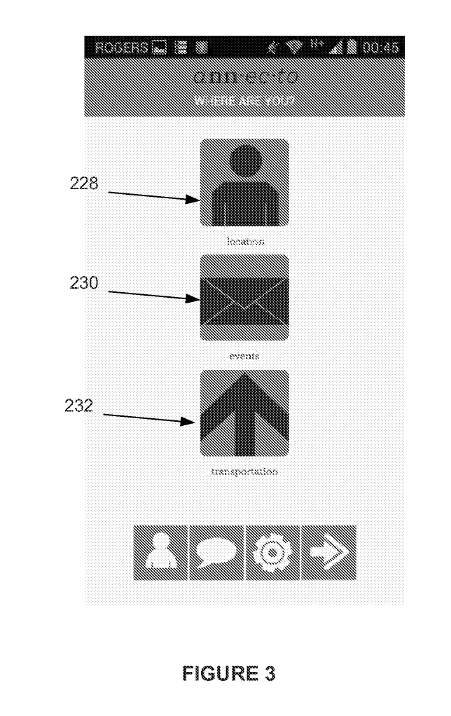

In another embodiment, the system may be used in connecting users at events or based on locations. FIG. 3 illustrates different location options for connecting with users using the present embodiments. For example, as shown in FIG. 3, the user may choose to connect with other users based on locations as shown at 228, in events as shown at 230 and in transportation as shown and discussed above.

For example, if the user chooses the option 232 they may be directed to FIG. 2g to choose the type of transportation.

If the user chooses the option 228 the server may select users that are in the proximity of the user in real time. For example, if the user decided to meet people in a given area or radius, they may enter such into in their preferences and the server may filter the users based on their current locations to make available user profiles that are within the area specified by the user performing the search. Determination of the location may be done in a variety of methods including but not limited to geosensing devices provided in the portable device such as GPS, base stations with which the portable device is connected, a wifi or hotspot to which the portable device is connected, and a variety of other methods which are known in the art.

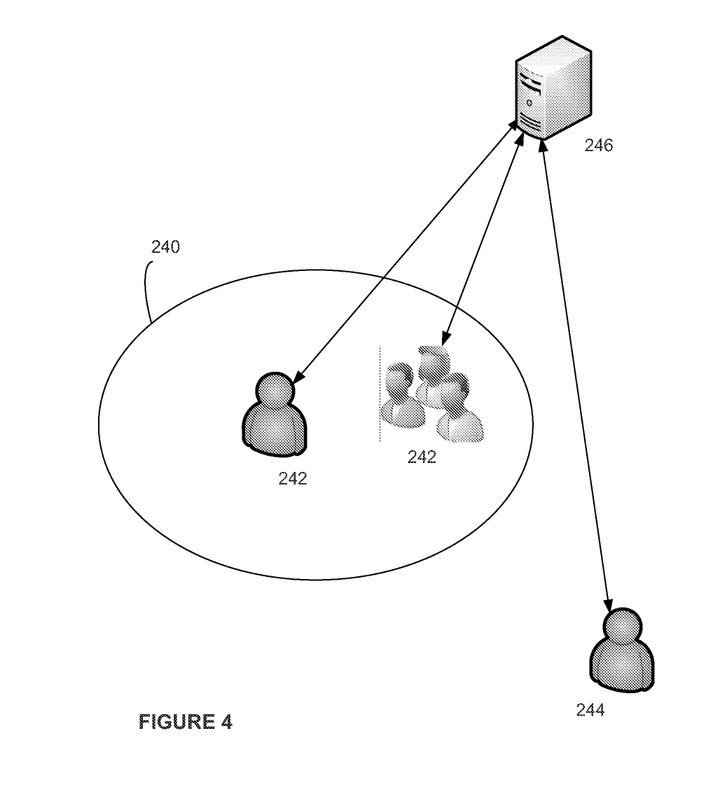

In an embodiment, if the user chooses the option 230, they may be asked to provide the security code as exemplified in FIG. 2f. The security code may in this case be a hashtag that is previously provided to the user when registering or buying a ticket for the event. In an embodiment, the hashtag may be geofenced whereby, hashtags used for authenticating from locations that are outside the geofence may not be granted access. An example is shown in FIG. 4. FIG. 4 illustrates an example of an area 240 that represents a geofence for a given hashtag associated with an event. In the present case, users 242 that are within the geofence 240 may upon providing the proper hashtag be granted access to view the profiles of other users that are within the geofence 240. However, user 244 who is outside of the geofence 240 may not be granted access if they are registered and even if they provide the proper hashtag. This method allows for restricting access to attendees who are within a predefined distance.

In operation, when users 242 request access to the server 246, they may enter the hashtag which represents the security code, and their mobile device may also send its current position when the access is requested. If the current position is within the geofence 240 such as the case for users 242, the access is granted. Otherwise, in the case that the current position is outside the geofence 240, such as the case for user 244 the access is denied.

In an embodiment, the application can be linked to the Twitter® platform (or any other social media using hashtag or any other sign as a classification mechanism). If linked, hashtags created on Twitter® may automatically create a (non geofenced) networking event/platform/chatroom on the application where users could look for and connect to a person of interest. The application may also be integrated in the Twitter® platform (or any similar platform) to allow users to the search for people using a hashtag.

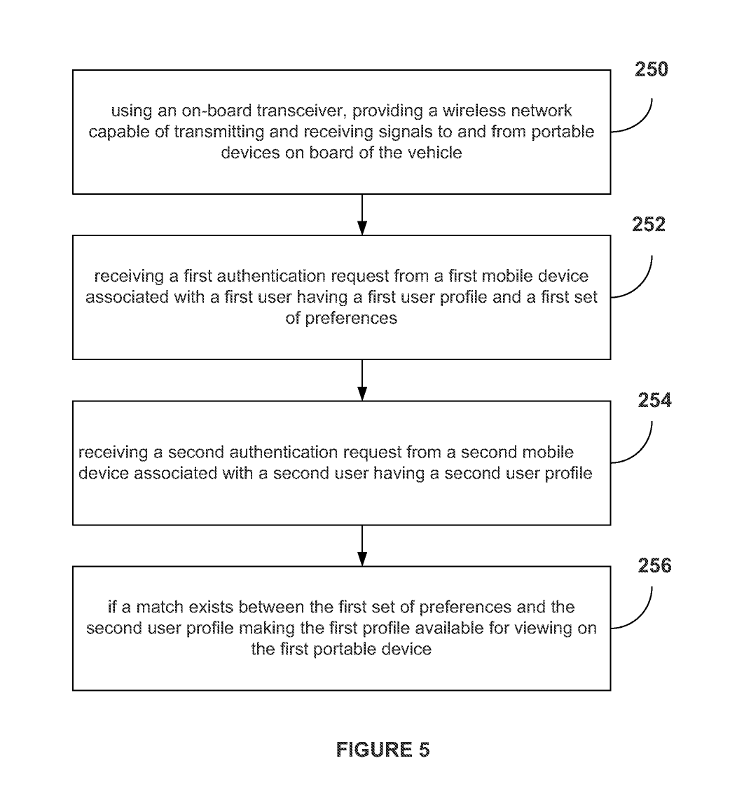

FIG. 5 is flowchart of a method for connecting users on board of a transportation vehicle, in accordance with an embodiment. Step 250 comprises, using an on-board transceiver, providing a wireless network capable of transmitting and receiving signals to and from portable devices on board of the vehicle. Step 252 comprises receiving a first authentication request from a first mobile device associated with a first user having a first user profile and a first set of preferences. Step 254 comprises receiving a second authentication request from a second mobile device associated with a second user having a second user profile. Step 256 comprises if a match exists between the first set of preferences and the second user profile making the first profile available for viewing on the first portable device.

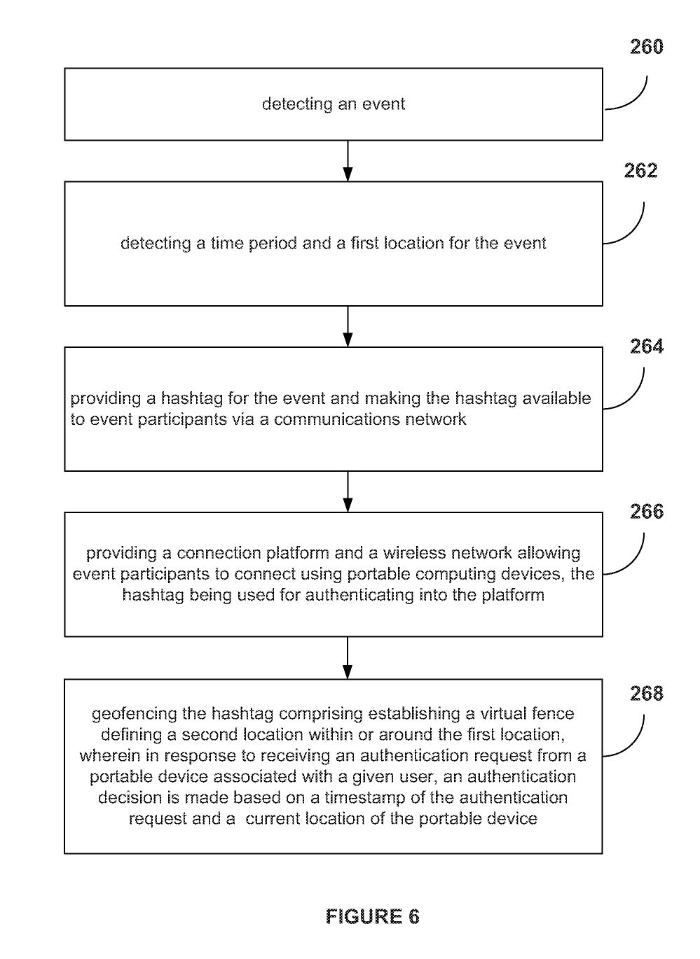

FIG. 6 is flowchart of a method for managing a location-based networking system. Step 260 comprises detecting an event. Step 262 comprises detecting a time period and a first location for the event. Step 264 comprises providing a hashtag for the event and making the hashtag available to event participants via a communications network. Step 266 comprises providing a connection platform and a wireless network allowing event participants to connect using portable computing devices, the hashtag being used for authenticating into the platform. Step 268 comprises geofencing the hashtag comprising establishing a virtual fence defining a second location within or around the first location, wherein in response to receiving an authentication request from a portable device associated with a given user, an authentication decision is made based on a timestamp of the authentication request and a current location of the portable device

### Hardware and Operating Environment

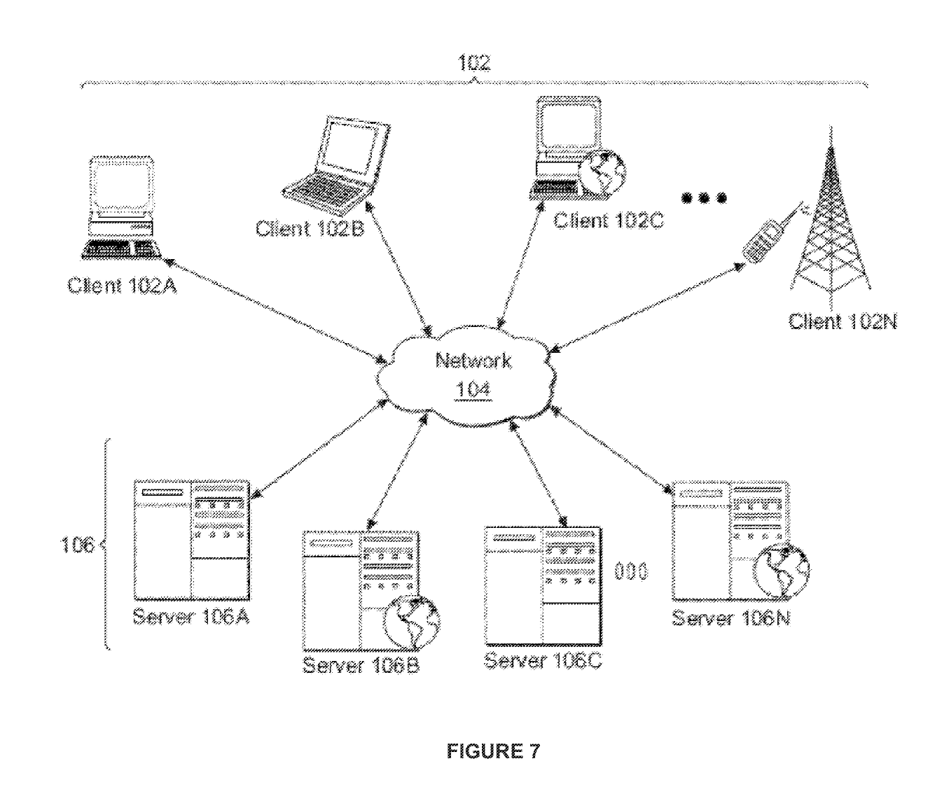

FIG. 7 illustrates an embodiment of a computing environment which is suitable for practicing the embodiments.

Embodiments of the invention may be implemented/operated using a client machine. The client machine can be embodied in any one of the following computing devices: a handheld computer; a mobile telephone; a portable telecommunication device; a media playing device; a gaming system; a mobile computing device; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; a computing workstation; a desktop computer; a tablet, a laptop or notebook computer; a server; or any other type and/or form of computing, telecommunications or media device that is capable of communication and that has sufficient processor power and memory capacity to perform the methods and systems described herein. In other embodiments the client machine can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein.

Still other embodiments of the client machine include a mobile client machine that can be any one of the following: any one series of Blackberry, Playbook or other handheld device manufactured by Research In Motion Limited; the iPhone manufactured by Apple Computer; Windows Phone 7, HTC, Sony Ericsson, any telephone or computing device running the Android operating system, or any handheld or smart phone; a Pocket PC; a Pocket PC Phone; or any other handheld mobile device supporting Microsoft Windows Mobile Software, etc.

The client machine may include a display and a touch-sensitive surface. It should be understood, however, that the computing device may also include one or more other physical user interface devices, such as a physical keyboard, a mouse and/or a joystick.

The client machine may be in communication with a remote server via a communication network. In another implementation, the data may be loaded from a local database or from local data files e.g. XML, JSON etc.

FIG. 7 illustrates an embodiment of a computing environment 101 that includes one or more client machines 102A-102N in communication with servers 106A-106N, and a network 104 installed in between the client machines 102A-102N and the servers 106A-106N. In some embodiments, client machines 102A-10N may be referred to as a single client machine 102 or a single group of client machines 102, while servers may be referred to as a single server 106 or a single group of servers 106. One embodiment includes a single client machine 102 communicating with more than one server 106, another embodiment includes a single server 106 communicating with more than one client machine 102, while another embodiment includes a single client machine 102 communicating with a single server 106.

The client machine 102 may in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 102. Still other embodiments may include a computing environment 101 with an application that is any of either server-based or remote-based, and an application that is executed on the server 106 on behalf of the client machine 102. The client machine 102 may include a network interface to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above.

The computing environment 101 can in some embodiments include a server 106 or more than one server 106 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 configured to operate as an active direction; a server 106 configured to operate as application acceleration application that provides firewall functionality, application functionality, or load balancing functionality, or other type of computing machine configured to operate as a server 106. In some embodiments, a server 106 may include a remote authentication dial-in user service such that the server 106 is a RADIUS server.

The network 104 between the client machine 102 and the server 106 is a connection over which data is transferred between the client machine 102 and the server 106. Although the illustration in FIG. 14 depicts a network 104 connecting the client machines 102 to the servers 106, other embodiments include a computing environment 101 with client machines 102 installed on the same network as the servers 106. Other embodiments can include a computing environment 101 with a network 104 that can be any of the following: a local-area network (LAN); a metropolitan area network (MAN); a wide area network (WAN); a primary network comprised of multiple sub-networks located between the client machines 102 and the servers 106; a primary public network with a private sub-network; a primary private network with a public sub-network; or a primary private network with a private sub-network. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 104 that includes a wireless link where the wireless link can be an infrared channel or satellite band; or any other network type able to transfer data from client machines 102 to servers 106 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 102 to servers 106, and vice versa, to accomplish the methods and systems described herein. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A computer implemented method for connecting users on board of a transportation vehicle, the method comprising:
using an on-board transceiver, providing a wireless network capable of transmitting and receiving signals to and from portable devices on board of the transportation vehicle;
receiving a first authentication request from a first mobile device associated with a first user having a first user profile and a first set of preferences;
receiving a second authentication request from a second mobile device associated with a second user having a second user profile;
if a match exists between the first set of preferences and the second user profile making the first profile available for viewing on the first portable device.

2. The method of claim 1 further comprising:
detecting a user-request from the first user initiating a chatting session with the second user;
receiving messages from the first user and sending the received messages to the second user over the wireless network and vice versa.

3. The method of claim 1 further comprising storing user profiles and sets of preferences associated with subscribed users on an accessible memory device.

4. The method of claim 1, further comprising storing messages exchanged in a given chatting session on an accessible memory device.

5. The method of claim 1, wherein users authenticated using social network login information associated with social networks with which the users have open accounts.

6. The method of claim 5, further comprising receiving profile information for the users from the social networks and storing said profile information on an accessible memory device.

7. The method of claim 1, further comprising requesting a security code for authenticating.

8. The method of claim 7, wherein the security code is one of: flyer number, hashtag, and PIN.

9. A system for connecting users on board of a transportation vehicle, the system comprising:
a server having access to a memory device having stored thereon profile information for a plurality of users;
a transceiver operably connected to the server, the transceiver being adapted to provide a wireless network capable of transmitting and receiving signals to and from portable devices on board of the transportation vehicle;
wherein the server is adapted to manage authentication requests between users including making available the profile information of a first user to a second user based on preferences and stored profile information associated with the first user and the second user.

10. The system of claim 9, wherein the system is adapted to allow on board chatting between users over the wireless network.

11. The system of claim 10, wherein the system detects a user-request from the first user initiating a chatting session with the second user; and receives messages from the first user and sends the received messages to the second user over the wireless network and vice versa.

12. The system of claim 11, wherein the system is adapted to store the messages exchanged in a given chatting session on the memory device.

13. The system of claim 9 wherein users are authenticated using social network login information associated with social networks with which the users have opened accounts.

14. The system of claim 13, wherein the system is adapted to receive profile information for the users from the social networks and store said profile information on the memory device.

15. The system of claim 9, wherein the system requests a security code for authenticating users.

16. The system of claim 15, wherein the security code is one of: flyer number, hashtag, and PIN.

17. A computer implemented method for managing a location-based networking system, the method comprising:
detecting an event;
detecting a time period and a first location for the event;
providing a hashtag for the event and making the hashtag available to event participants via a communications network;
providing a connection platform and a wireless network allowing event participants to connect using portable computing devices, the hashtag being used for authenticating into the location-based networking system;
geofencing the hashtag comprising establishing a virtual fence defining a second location within or around the first location, wherein in response to receiving an authentication request from a portable device associated with a given user, an authentication decision is made based on a timestamp of the authentication request and a current location of the portable device.

18. The method of claim 17, further comprising receiving location coordinates of the portable device and comparing whether or not the portable device exists within the second location defined by the virtual fence.

19. The method of claim 17, further comprising storing messages exchanged between users on an accessible memory device.
